(19) United States
(12) Patent Application Publication
(10) Pub. No.: US 2017/0171050 A1
(43) Pub. Date: Jun. 15, 2017

(54) A SYSTEM AND METHOD FOR INTEGRATING LEGACY FLOW-MONITORING SYSTEMS WITH SDN NETWORKS

(71) Applicant: B.G. Negev Technologies and Applications Ltd., at Ben-Gurion University, Beer Sheva (IL)

(72) Inventors: Rami PUZIS, Ashdod (IL); Luiza NACSHON, Sderot (IL)

(73) Assignee: B.G. Negev Technologies and Application Ltd., at Ben-Gurion University, Beer Sheva (IL)

(21) Appl. No.: 15/117,803

(22) PCT Filed: Feb. 15, 2015
(86) PCT No.: PCT/IL2015/050170

§ 371 Date: Aug. 10, 2016

Related U.S. Application Data
(60) Provisional application No. 61/940,444, filed on Feb. 16, 2014.

(51) Int. Cl. H04L 12/26; H04L 12/24; H04L 12/803; H04L 12/741

(52) U.S. Cl. CPC H04L 43/0876; H04L 43/04; H04L 45/54; H04L 41/12; H04L 47/125

(57) ABSTRACT

The present invention relates to a system and method for mediating between SDN based networks and common flow-monitoring systems. The present invention transfer data from an SDN controller, to a traditional flow monitoring system, by using a proxy based method within the NFO (Net Flow for Open Flow) framework. In an embodiment of the invention, the invention relates to a flow discovery method, which can efficiently discover newly active flows that pass through the network and so the present invention collects data and statistic in a very effective way while spending resources only on flows that need to be monitored.

### FIELD OF THE INVENTION

The invention is in the field of computer communication systems. More specifically the invention relates to a system and method for integrating legacy flow-monitoring with Software-Defined-Networking networks and optimization of the flow statistics collection process.

### BACKGROUND OF THE INVENTION

Software Defined Networking (SDN) is a new paradigm that segregates the routing data-plane (packet forwarding) from the routing control-plane (routing decisions and advanced protocols). In conventional networks both the data-plane and the control-plane are managed by the same network device. In SDNs, however, the control-plane is implemented by a remote software-based controller. Due to this segregation SDN devices are simpler, cheaper, and more efficient than regular network devices and require less firmware updates. The agility, flexibility, and lower operational expenses of SDN make it a natural solution for the highly dynamic cloud networks. [Greenberg, Albert, James R. Hamilton, Navendu Jain, Srikanth Kandula, Changhoon Kim, Parantap Lahiri, David A. Maltz, Parveen Patel, and Sudipta Sengupta. “VL2: a scalable and flexible data center network.” In ACM SIGCOMM Computer Communication Review, vol. 39, no. 4, pp. 51-62. ACM, 2009].

OpenFlow (OF) is a protocol which implements the SDN paradigm by enabling the communication between the controller and the networking devices. OF which was developed for research purpose has been adopted by corporations such as Google and Hewlett Packard due to its flexibility and ease of management as described at Lara, Adrian, Anisha Kolasani, and Byrav Ramamurthy. “Network innovation using openflow: A survey”. (2013): 1-20.

Unfortunately, most of the existing network management and security infrastructures are not yet ready to support OF. As SDN and OF are new network concepts, currently standard monitoring systems are not able to receive OF data and analyze it. In particular, this applies to Network based Intrusion Detection Systems (NIDS) that are an essential component in modern networks. Existing NIDSs fail to adjust to the rapidly developing OF technology. Many NIDSs rely on statistics collected from network flows using specialized (and in many cases vendor specific) protocols such as NetFlow, JFlow, sFlow, IPFIX etc. Although, there are security systems for SDN they either (1) require hybrid switches (2) introduce modifications into OpenFlow specifications or (3) built for SDN only. It will take time until major security brands release OF enabled versions of their existing products, as described at Alaidaros, Hashem Mohammed, Massudi Mahmuddin, and Ali Al Mazari. “From Packet-based Towards Hybrid Packet-based and Flow-based Monitoring for Efficient Intrusion Detection: An overview.” (2012) and Bin, Liu, Lin Chuang, Qiao Jian, He Jianping, and Peter Ungsunan. “A NetFlow based flow analysis and monitoring system in enterprise networks.” Computer Networks 52, no. 5 (2008): 1074-1092.

Prior art try to fill the void due to the lack of NIDSs that support OF for example, Kumar, T., Singh, G., & Nehra, M. S. Open Flow Router with Intrusion Detection System, IJSRET Vol. 1 no. 7, pp 1-4, 2012. Other examples are Braga Rodrigo, Edjard Mota, and Alexandre Passito. “Lightweight DDoS flooding attack detection using NOX/OpenFlow.” In Local Computer Networks (LCN), 2010 IEEE 35th Conference on, pp. 408-415. IEEE, 2010, and InMon, sFlow-RT, http://www.inmon.com/products/sFlow-RT.php. Many of the proposed monitoring schemes require deviations from standard implementations of OF components. For example, Kumar et al. introduced additional instructions for the flow-tables of OF routers (i.e. IP verification and packet verification). Rodrigo et al. proposed modifying the NOX controller to collect flow statistics and extract required features from the flows for later classification. InMon et al. presented sFlow-RT, where modified OF routers export sFlow datagrams. However, so far there is no method for integration of existing flow-based NIDS with OF networks without changing the specifications and the implementation of OF components.

In addition, OpenFlow provides basic mechanisms for flow monitoring (e.g. collecting traffic flow statistics). Since flow monitoring consumes network resources its careless and pervasive usage can reduce the network performance.

It is therefore an object of the present invention to utilize the flexibility and agility of OpenFlow to reduce the overhead of collecting high granularity flow statistics and to balance the monitoring effort among OpenFlow routers.

It is another object of the present invention to provide a method and system for integrating existing flow-based NIDS with OpenFlow networks without changing the specifications and the implementation of OpenFlow components.

It is yet another object of the present invention to provide a method and system for optimized flow monitoring in OpenFlow networks.

Further purposes and advantages of this invention will appear as the description proceeds.

### SUMMARY OF THE INVENTION

In one aspect the present invention is a system for mediating between Software-Defined-Networking and common flow-based monitoring systems, said system comprises:
a) an SDN controller, operating in SDN technology;
b) NetFlow to OpenFlow module, for receiving flow statistics from said SDN controller, converting the flow statistics to datagram, and exporting the datagram by standard monitoring traffic protocols to a remote monitoring system; and
c) said remote monitoring system, for receiving the datagram from said NetFlow to OpenFlow module.

In an embodiment of the invention the SDN technology is implemented by OpenFlow protocol.

In an embodiment of the invention the remote monitoring system is a Network Intrusion Detection System (NIDS).

In an embodiment of the invention the NetFlow to OpenFlow module comprises the following modules:
a) a flow discovery module, for generating aggregated flow-discovery entries by selecting routes passing through Selected Routers, and determining source and target subnets at each endpoint;
b) a flow assignment module, for balancing monitoring load across network routers, by instructing said flows discovery module as to where each flow-discovery entry should be installed, based on the capacities and occupations of said routers flow-tables,
c) a scheduler module, for installing for each active flow a schedule of entries expirations, thereby to collect high granularity statistics; and
d) data export module, for listening to flow-removed messages from each of said active flows installed by said scheduler module, generating corresponding NetFlow datagrams, and sending said corresponding NetFlow datagrams to a remote NetFlow Collector.

In another aspect the invention is a method for mediating between SDN networks and common flow-based Network based Intrusion Detection Systems, wherein a NetFlow to OpenFlow module receives flow statistics from said SDN controller, converts said flow statistics to datagram and exports said datagram by standard monitoring traffic protocols; and wherein said method comprising the steps of:
a) selecting routes passing through NetFlow Enable Routers;
b) generating aggregated flow discovery entries;
c) installing said aggregated flow discovery entries;
d) listening to packet-in messages;
e) setting the monitoring frequency of an active flow;
f) installing an exact match entry for said active flow on router R;
g) listening to flow remove messages;
h) extracting statistic of said flow from said flow;
i) exporting NetFlow datagram;
j) updating monitoring frequency of said active flow;
k) reinstalling said active flow on said same router.

In an embodiment of the invention the method comprises the steps of:
a) generating aggregated flow-discovery entries by selecting routes passing through selected routers, and determining source and target address spaces at each endpoint;
b) balancing monitoring load across network routers, by instructing said flows discovery module as to where each flow-discovery entry should be installed, based on the capacities and occupation of said routers flow-tables;
c) installing for active flows and scheduling said entries expiration in order to collect high granularity statistics; and
d) listening to flow-removed messages from said active flows installed by said Scheduler module, generating corresponding NetFlow datagrams and sending said corresponding NetFlow datagrams to a remote NetFlow Collector.

In an embodiment of the invention the balancing monitoring load across network routers comprises the steps of:
receiving as an input a set of flow-discovery entries, and routes of respective flows;
balancing a monitoring load relying on a number of free flow-table entries in each candidate router;
iterating over all flow-discovery entries in the order of non-increasing load;
assigning each entry to a router along said router path that has a maximal number of free flow-table entries; and
updating a number of free flow-table entries, based on an expected load on said router.

In another aspect the invention is a method for discovering new active flows, which pass in a network and collecting statistic about said active flows; said method comprises the steps of:
a) initializing a set of flow-discovery entries and a map of flows to selected routers through which said flows pass;
b) iterating over all subnets connected to all source and destination routers;
c) generating for each pair of subnets a flow-discovery entry;
d) saving for future use only if at least one of said selected routers is along its route;
e) saving the selected routers where each flow could have been monitored, for later use;
f) invoking Flows Assignment module to determine a location of each flow discovery entry;
g) installing on the assigned router each of said generated flow-discovery entries; and
h) transferring to Data Export module two maps, which: (a) define for each flow on which selected router each of said flows could have been collected; and (b) where each of said flows is collected in the OpenFlow network.

All the above and other characteristics and advantages of the invention will be further understood through the following illustrative and non-limitative description of embodiments thereof, with reference to the appended drawings.

### BRIEF DESCRIPTION OF THE DRAWINGS

FIG. 1 schematically shows the method of the present invention according to an embodiment of the present invention;

FIG. 2 schematically shows the architecture of the system of the invention according to an embodiment of the invention;

FIG. 3 schematically shows an example of the unbalanced assignment vs. a balanced assignment according to an embodiment of the invention;

FIG. 4 schematically shows the three major parts of the monitoring process;

FIG. 5 schematically shows pseudo code implementing the flow discovey module, according to an embodiment of the invention;

FIG. 6 schematically shows pseudo code implementing the flow assignment module, according to an embodiment of the invention; and

FIG. 7 schematically shows an example of a table of a detailed conversion map between OpenFlow data to NetFlow.

FIGS. 8a-8c schematically show control messages as a function of time for ping cycle length of 1 second and flow-table sizes of 1000 entries;

FIG. 9 schematically shows the number of packet-in messages vs. full flow-table errors

FIGS. 10a-10c schematically shows control messages vs. the flow-table size for ping cycle of 4 seconds;

FIG. 11 schematically shows the total number of used flow entries;

FIGS. 12a-12c schematically shows control messages vs. ping cycle length for the flow-table size of 1000;

FIG. 13 schematically shows the amount of collected statistics;

FIG. 14 schematically shows the total number of packet in messages vs. the Gini coefficient of free flow-table entries across all routers; and

FIG. 15 schematically shows the average memory usage of the Floodlight controller.

### DETAILED DESCRIPTION OF EMBODIMENTS OF THE INVENTION

The present invention relates to a system and method for mediating between SDN based networks and common flow-monitoring systems. The present invention transfer data from an SDN controller, to a traditional flow monitoring system, by using a proxy based method within the NFO (NetFlow for OpenFlow) framework. In an embodiment of the invention, the invention relates to a flow discovery method, which can efficiently discover newly active flows that pass through the network and so the present invention collects data and statistic in a very effective way while spending resources only on flows that need to be monitored.

For simplicity the present invention relates to OpenFlow which is a protocol, that is used to implement the SDN technology and to Network based Intrusion Detection Systems (NIDS). However any other SDN protocols any other flow monitoring system can be used.

The NFO framework module enables the integration of legacy flow-based monitoring systems with Software Defined Networks (SDN). NFO includes a set of components for discovering active flows (the flow that becomes active) in the network, balancing the network resources used for collecting statistics, and exporting the collected statistics to an external monitoring system.

NFO converts flow statistics received from an OpenFlow Controller (OFC) to datagrams exported by standard traffic monitoring protocols. Although the present invention focuses on NetFlow protocol, it can be extended to support other similar protocols as well. NFO allows incremental upgrade to OF networks without replacing the existing Network based Intrusion Detection Systems (NIDS) and without compromising the quality of attack detection. In fact, NFO architecture utilizes the flexibility of OpenFlow (OF) to reduce the overhead of traffic monitoring, increase the granularity of inspected flows, and balance network resources used for monitoring.

OF routers (sometimes referred to as switches due to their simplicity and mode of operation) maintain at least one flow-table. Every flow-table contains entries that correspond to traffic flows similar to the NetFlow cache. Flow-table-entries can be installed proactively by the network manager (e.g. static routing) or reactively upon an arrival of new active flow. Every flow-entry has a priority, a hard timeout, an idle timeout, action, and finally packet and byte counters. Actions can be used, for example, to control packet forwarding or to relay routing decisions to the OF controller. Typically, every router contains a default zero-priority wildcarded flow-table-entry that contains instructions for unmatched packets. For example, dropping the packet or sending a packet-in message to the OF controller. Based on the packet headers, which is contained in the packet-in messages, the OF controller computes the optimal route of new flows and installs respective flow-table-entries via flow-mod messages. Typically the source field in the new entries is wildcarded while the action is forwarded to a specific interface. Flow installation fails when the router's flow-tables are full.

The OF controller may also set a SEND_FLOW_REM flag on, in a new entry, to indicate that flow statistics should be sent to the OF controller upon flow termination, similarly to NetFlow export. This, push-based method of statistics collection along with flow timeout manipulation is more scalable, accurate, and flexible than pull-based methods.

Generally, remote applications control network's behavior through the northbound API of the OF controller.

In order to maintain the routine of network monitoring, the present invention allows network administrators to select the NetFlow Enabled Routers (NERs). The designated NetFlow collector or any other NIDS should receive statistics on all flows passing through these Selected Routers (i.e. NERs). Unfortunately, the individual flows whose statistics need to be collected are not known a priori. Therefore, another embodiment of the present invention, presents a new Flow Discovery technique that requires only several additional control messages and flow-table entries distributed wisely across the network to avoid overload. Said flow-table entries are referred to herein after as flow-discovery entries.

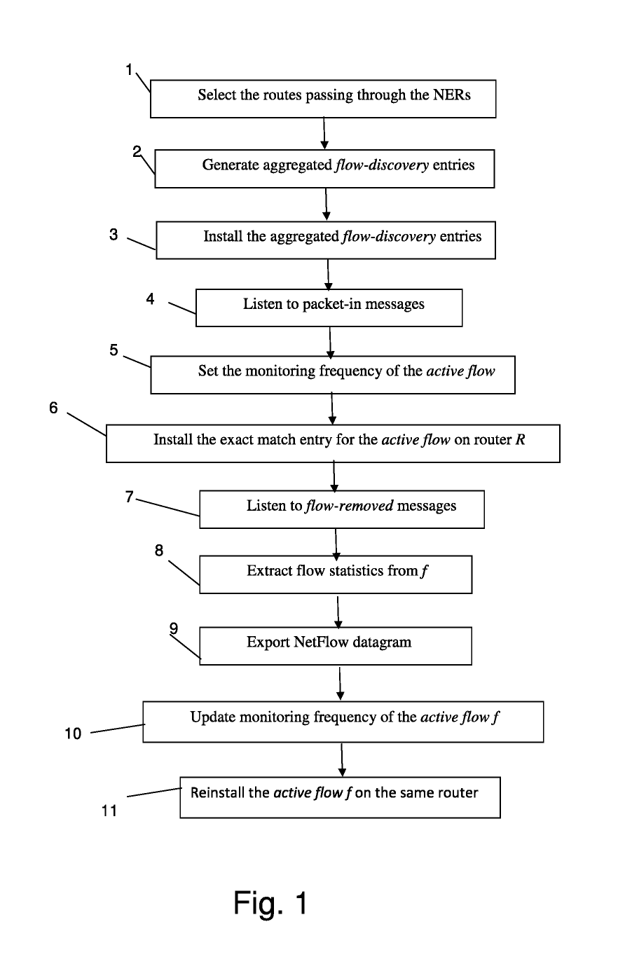

FIG. 1 schematically describes the method of the present invention for the monitoring approach of the invention according to an embodiment of the present invention. Accordingly, in step 1, NFO module first selects the routes passing through the NERs. In step 2, NFO generates aggregated static flow-discovery entries for routes selected in step 1 in order to discover new active flows. In step 3, NFO installs the flow-discovery entries such that the monitoring load is equally balanced across the network routers. The action field of the flow-discovery entries is set to “send to controller”. In step 4, once the entries are installed, NFO listens to packet-in messages triggered by new active flows.

Figuratively speaking, flow-discovery entries are used to trap active flows. In step 5, an active flow is trapped when its first packet matches the flow-discovery entry. When this happens, the router generates the packet-in message. Then, in step 6, NFO receives the packet-in message, and reacts by installing exact-match flow-table entries for the newly discovered active flow in order to collect statistics. The timeouts of active flows and hence the frequency of the statistics collection is determined in step 5 and in step 10 by a pluggable scheduling algorithm known in the art, for example, an adaptive scheduling algorithm provided by PayLess [Chowdhury, Shihabur Rahman, Md Faizul Bari, Reaz Ahmed, and Raouf Boutaba. “PayLess: A Low Cost Netowrk Monitoring Framework for Software Defined Networks.” In 14th IEEE/IFIP Network Operations and Management Symposium (NOMS 2014) (To appear). 2014.].

In steps 6 and 11, active flows are installed with a flow-removed flag set. The action field of an active flow entry instructs the router to forward the packet according to the routing strategy used in the network. When NFO module receives a flow-removed message generated due to the expiration of an active flow, first the NFO extracts the flow statistics as described in step 8, an then, in step 9, NFO generates a NetFlow datagram and sends it to the NetFlow Collector, which is the NIDS which enable to receive NetFlow data only. In step 10, the monitoring frequency of the active flow is updated and in step 11 the active flow is reinstall on the same router.

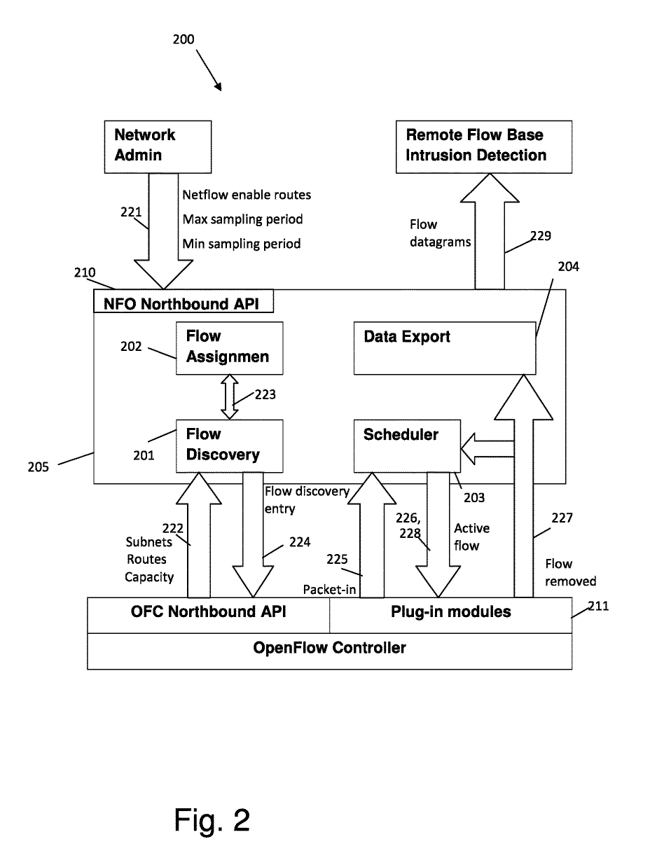

FIG. 2 schematically describes the architecture of the system of the invention according to an embodiment of the invention.

Architecture 200 comprises modules, which are responsible for: (a) generating the relevant flow-discovery entries (b) assigning them to routers (c) scheduling the expiration of active flows and (d) exporting flow statistics to the remote flow analyzer.

The Flows Discovery module 201 generates the aggregated flow-discovery entries by selecting the routes passing through the NetFlow Enabled Routers (NERs), and determining the source and target subnets, where subnet is a set of consecutive IP addresses having a common prefix, at each endpoint (i.e. edge router, cluster or server rack mount). The endpoint routers, their subnets, and the routes between the endpoint routers are retrieved from the controller as can be seen in interaction 222 in FIG. 2.

The Flows Assignment module 202 is responsible for balancing monitoring load across the network routers. Based on the capacities and occupation of router flow-tables, The Flows Assignment module 202 instructs the Flows Discovery module 201 as to where each flow-discovery entry should be installed (as can be seen in interaction 223 in FIG. 2).

The Scheduler module 203 is responsible for installing entries for active flows and scheduling their expiration (i.e., the monitoring frequency) in order to collect high granularity statistics as shown in interactions 226 and 228 in FIG. 2.

Data Export module 204 listens to flow-removed messages from the active flows installed by the Scheduler 203 at interaction 227 in FIG. 2, and in interaction 229 generates corresponding NetFlow datagrams and sends them to a remote NetFlow Collector.

The NFO Northbound API layer 210 is used to define the monitoring protocol (e.g. NetFlow, sFlow etc.) and the maximal and the minimal delay between measurements, (d_max and d_min respectively).

Flow Assignment module 202 maps flows that need to be monitored to routers based on up-to-date network state. It periodically extracts the network topology and the number of free flow-table entries in candidate routers from the OFC.

A plug-in module 211 within the OFC receives all the messages from the OFC and forward the messages to the modules in the NFO framework. when a flow-removed messages is received it is forwarded to the scheduler module 203, which reschedule the flow and send the statistics information to the data export module 204)

NFO module 205 was tested with Floodlight controller which includes OF protocolversion 1.0. The network was emulated with Mininet and OpenVSwitch. The collected statistics were exported as NetFlow v5 datagrams to the Advanced Security Analytics Module (ASAM) as a client NIDS. Since the identity of the monitored router is important for some NIDSs, NFO module 205 exports the datagrams with spoofed source address that corresponds to IP of the “router” where the statistics should have been collected.

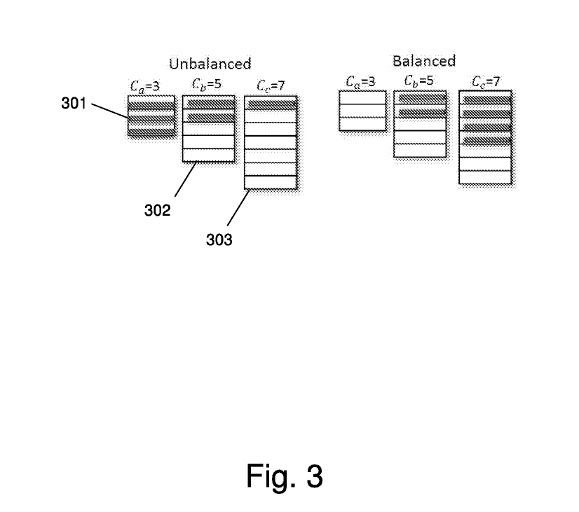

Since flow installation fails when flow tables are full, there is a need to avoid overloading of flow tables with entries installed for the purpose monitoring. Unbalanced distribution of flows can result in some flow tables being fully loaded. FIG. 3 shows an example where router 301 is full. The objective of Flow Assignment module 202 is to assign flow table entries such that the number of free flow table entries is evenly distributed.

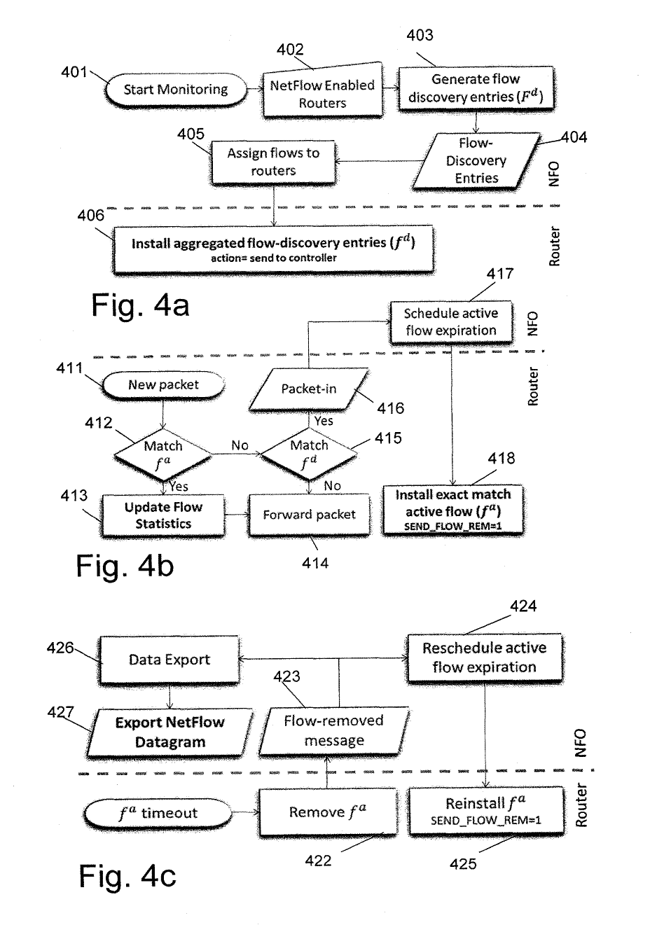

FIG. 4 schematically describes the three major parts of the monitoring process.

FIG. 4 summarizes the full process from NERs selection, generation of flow-discovery entries of all subnets passing through each NER, the scheduling of active flows and the export of the statistics of active flows to NIDS.

During the first stages of the monitoring commencement, as shown in step 401, NFO analyzes the underlying network in order to select routes passing through the NERs as shown in step 402 and to generate the respective flow-discovery entries in step 403. In step 404, flow discovery entries are generated, and in step 405 the NFO assign flows to routers by the flow assignment module. The next step 406 is to install aggregated flow-discovery entries.

The next stage shown in FIG. 4b is carried out by the scheduler module. When a new packet is received in step 411, the scheduler checks if it matches flow entry f^{a} in step 412. If yes the next step is 413, and the scheduler updates the flow statistics, and in step 414 forwards the packet. In case the new packet does not match the active flow f^{a} then step 415 is applied and it is checked if the packet matches flow-discovery f^{d}, if yes, step 416 is applied and packet-in message is generated and the next step is 417, where the scheduler module schedule active flow expiration. In step 418 the scheduler reinstalls the exact match active flow.

If the packet does not match flow-discovery entry f^{d} then step 414 is applied and the packet is forwarded.

The last part of FIG. 4 is carried out by the data export module as shown in FIG. 4c. When a flow entry in the flow-table of the router expires due to a timeout determined by the scheduler module. the flow is removed from the flow-table as described in step 422, and a flow removed message is sent in step 423 to the scheduler and to the data export modules. The scheduler in step 424 reschedule active flow expiration and in step 425 reinstall the flow in the router. The data export module in step 426 receives the flow-removed message and in step 427 exports NetFlow datagram.

Function G(V,E) denote the network topology where V is the set of routers and E is the set of links between them. Routers and links can be extracted via the Northbound API of Controller. Similarly it is possible to extract endpoints and routes between them. The data center edge routers is considered as a special case of endpoints that are the sources and destinations of the “North-South” traffic (that enters and exits the data center)

Every endpoint is a potential source and a potential destination of flows. Let S⊂V and T⊂gV be the sets of source and destinations routers respectively. Every traffic flow enters the network through a source router s∈S and leaves the network through a destination router t∈T.

The set of IP subnets is denoted by IP(v)={IP₁, . . . , IPn} this set of IP communicates with the network through the endpoint v∈SuT. Given an source router s∈S and an destination router, it can be distinguished between two types of flows: aggregated (IPi, IPj), where IPi∈IP(s) ΛIPj∈IP(t), and exact-match (ipₖ,. . . ipₗ) where ipₖ∈IPi and ipₗ∈IPj. For the sake of simplicity, in the rest of this application other flow attributes such as protocol type, ToS, etc. are ignored. F is defined as a set of aggregated flows between all pairs of source/destination routers:

F{(IPi, IPj)|IPi∈IP(s)ΛIPj∈IP(t)Λs∈SΛt∈T} (1)

Let R:F→2^{V} denote the function which maps a flow f∈F to its route {s, v₁, . . . , t}⊂V within the network. Although in general, routes are ordered sequences of routers, the order in this application is disregard. Flow-discovery entries is generated for a subset of aggregated flows F^{d}⊂F whose routes pass through at least one of the NERs:

F^{d}={f^{d}∈F|R(f^{d})∩NERs≠Ø} (1)

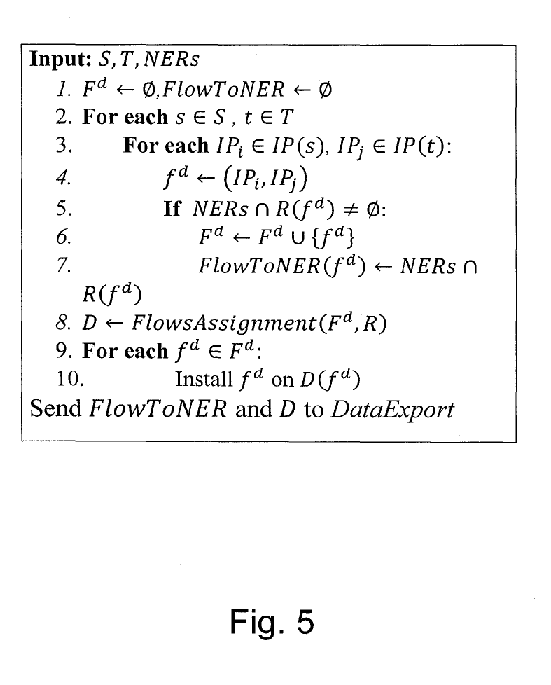

Given the sets of source and destination routers (S and T respectively) and the NERs defined by the network administrator, the Flow Discovery module 201 generates and installs static flow-discovery entries as summarized in the pseudocode in FIG. 5. Line 1 initializes the set of flow-discovery entries as well as the map of flows to NERs through which the flows pass. The FlowsToNER map may later be required by the Data Export module. Next, in lines 2-3, iterations over all subnets connected to all source and destination routers, are made. A flow-discovery entry is generated for each pair of subnets in line 4 and saved for future use only if at least one of the NERs is along its route (lines 5-6). the NERs where each flow could have been monitored for later use is saved in line 7.

In line 8, the Flows Discovery module invokes the Flows Assignment algorithm to determine the location of each flow discovery entry. The result of Flow Assignment is a function DₗF^{d}→V that maps flow-discovery entries to routers. Each generated flow-discovery entry is installed on the assigned router (see lines 9-10 in FIG. 5, FIG. 4.a, and interaction 224 in FIG. 2). Finally, the two maps, that (1) define for each flow on which NER it could have been collected (FlowToNER) and (2) where it should be collected in the OpenFlow network (D), are transferred to Data Export module.

Each flow-discovery entry f^{d}=(IPᵢ,IPₗ) represents an aggregation of flows between machines within the subnets IPᵢ and IPⱼ. Usually only few of these flows are simultaneously active. In order to discover these flows NFO sets the action field of the installed flow-discovery entries to send to controller and listens to incoming packet-in messages through the controller's native API.

A new active flow that matches a flow-discovery entry, denoted as f^{a}∈f^{d}, triggers a packet-in message on the router where f^{d} is installed. This message is received by the Scheduler (see FIG. 4.b) through the native API of the controller (see interaction 5 in FIG. 2).

At this point it is important to note that f^{a} must be installed on the same router as the flow-discovery entry that triggered the respective packet-in message. This is done in order to prevent packets, from the same flow triggering, additional packet-in messages.

It is also noted that Flow Discovery introduces an additional delay during initiation of monitored flows. When the first packet matching a flow-discovery entry arrives and triggers a packet-in message, the traffic flow is not immediately forwarded to the destination. The traffic forwarding continues after the active flow entry is installed .

Installing exact-match active flow entries significantly increases the number of flow-table entries installed on a router. As explained in above an overfull flow-table causes error messages when controller attempts to install new flow-table entries and creates congestion at the overloaded router. Therefore, it is very important to balance the monitoring load across the network routers in order to minimize the chance of exceeding the flow-table capacity.

The Flow Assignment module 202 is responsible for choosing the routers on which flow-discovery entries, generated by the Flow Discovery module, should be installed. Every flow-discovery entry (f^{d}) results in the installation of a number of exact-match active flow entries (f^{a}∈f^{d}) on the same router. the number of active flow entries that match the flow-discovery entry f^{d}=(IP_i,IP_j) is denoted as load(f^{d}). Let μ denote the expected fraction of active flows out of all possible flows matching f^{d}. The expected load created by f^{d} is

load(f^{d})=1+μ*|IP_i|*|IP_j| (2)

Where |IP_i| and |IP_j| are the number of addresses in the IP_i and the IP_j subnets respectively. The unity in Equation 2 represents the flow-discovery entry and μ*|IP_i|*|IP_j| is the expected number of active flows that match f^{d}.

Note that, although μ may vary considerably for various aggregated flows, for the sake of simplicity, the fraction of active flows between any two subnets is referred to as μ without additional indices or parameters. If required, μ can be efficiently estimated for all pairs of source/destination routers using periodical snapshots of router flow-tables or Traffic Matrix estimation techniques.

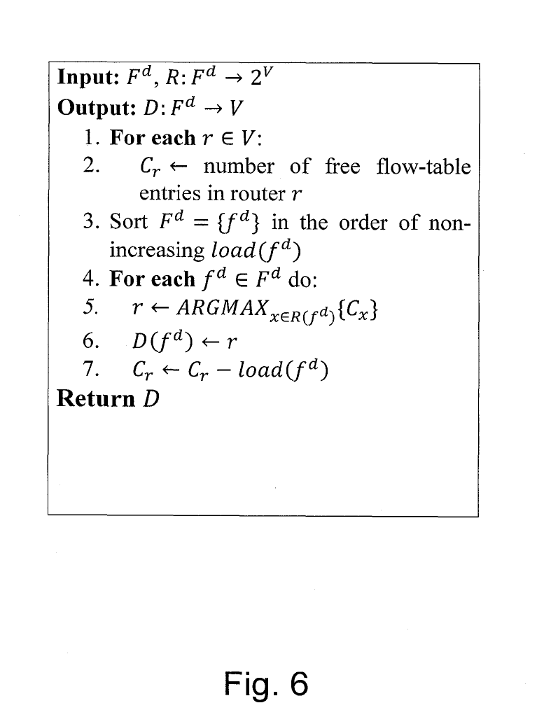

Efficient distribution of flow-discovery entries balances the load on routers across the network such that no router is overloaded. In another embodiment of the present invention, a simple yet efficient greedy algorithm is employed to balance load on routers as shown in the pseudo code algorithm of FIG. 6. The algorithm receives as an input the set of flow-discovery entries (F^{d}), computed in lines 1-6 of FIG. 5, and the routes of the respective flows (R: F^{d}→2^{V}). Balancing the monitoring load relies on the number of free flow-table entries (Cᵣ) in each candidate router (r∈V) (lines 1-2). The number of free and used flow-table entries can be extracted from the controller Northbound API. Next, the algorithm iterates over all flow-discovery entries in the order of non-increasing load (lines 3-4). Each entry (f^{d}) is assigned to the router along its path (R(f^{d})) that has the maximal number of free flow-table entries (lines 5-6). The number of free flow-table entries is updated based on the expected load (see Equation 2) on the chosen router in line 7.

It is noted that correct functioning of Flow Assignment relies on the estimation of the expected fraction of active flows (μ) and the estimation of the number of free flow-table entries for each candidate router. It is also noted that in algorithm of the flow assignment in FIG. 6, it was assumed that there are enough free flow-table entries to install at least the flow-discovery entries. The algorithm will still function correctly if the number of free flow-table entries is smaller than the expected number of active flow entries that may be installed there. In such cases errors will be reported by the routers during later stages. But using the Flow Assignment algorithm that balances the load reduces the number of such errors.

Following the installation of flow-discovery entries, as described above, the Scheduler module 203, listens to packet-in messages triggered by the flow-discovery entries module and installs respective exact-match active flow entries with the flow-removed flag set (see FIG. 4.b). The Scheduler module also listens to flow-removed messages triggered by the expiration of the installed active flows and re-installs these flows with adapted timeouts (see FIG. 4.c).

The main objective of the Scheduler module 203 is to adapt the expiration frequency of active flows to ensure: 1) the collection of high granularity statistics and 2) minimal bandwidth consumption (reflected by the number of flow-mod and flow-removed messages). If the statistics (packets and bytes counters) collected for some active flow are characterized by high variability over time, this flow is re-installed with a decreased timeout. In the opposite case, the active flow is re-installed with an increased timeout. The minimal and maximal timeouts are determined by the network administrator (interaction 1 in FIG. 3).

Upon the receipt of a packet-in message, triggered by a flow-discovery entry (f^{d}), the Scheduler installs an exact-match active flow entry (f^{a}) for the flow indicated in the packet-in message. f^{a} is installed on the same router where fd has been installed, but with higher priority than f^{d}. The action field of f^{a} instructs the router to forward matching packets according to the routing strategy used in the network. Packets matching f^{a} update the flow-table entry's counters and are forwarded to the defined output port.

When the active flow entry expires the entry is removed, its statistics are encapsulated in a flow-removed message according to OpenFlow specification. The message is sent to the controller. The controller passes the message to the Scheduler module through the native API (see interaction 7 in FIG. 2 and FIG. 4.c).

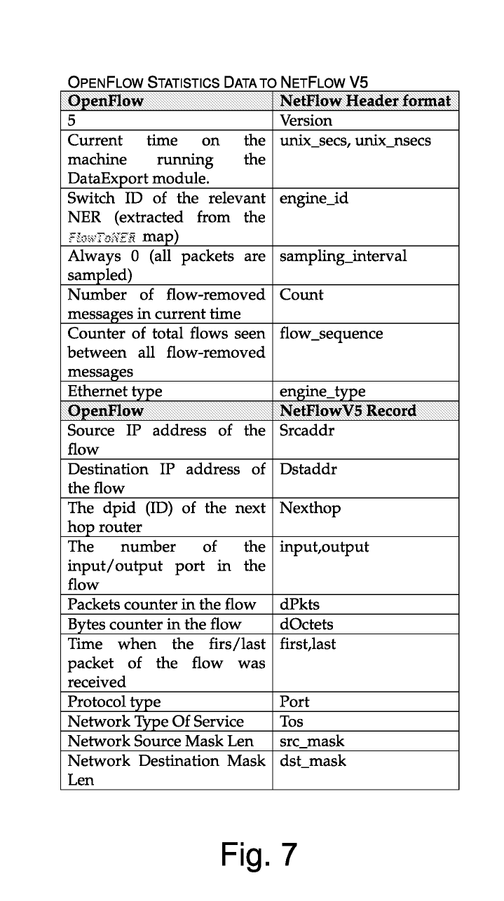

Data Export is the last module in the monitoring process. It is responsible for transferring the collected statistics to the remote NetFlow Collector. As explained above, both the NetFlow cache and the OpenFlow flow-tables contain statistics on flows. In addition, both NetFlow and OpenFlow support push-based monitoring. Hence, the Data Export module can push the data collected by exact-match active flow entries to the remote collector (see interaction 9 in FIG. 2 and FIG. 4.c). The Data Export module extracts statistics data from flow-removed messages triggered by active flows expiration and converts the data to NetFlow datagrams. FIG. 7 schematically shows an example of a table of a detailed conversion map.

It is noted that NetFlow collectors (such as flow-based NIDS) run on a remote server and receive NetFlow records traditionally exported using User Datagram Protocol (UDP). The Data Export module sets the destination address of the UDP packets to the IP address of the NetFlow collectors. Originally, the source address of the NetFlow datagrams should be the IP address of the NER interface from which the statistics were collected. For the sake of flow analyzers that utilize this information, NFO can set the source address of the exported datagrams such that either: (1) the changes in the monitoring process are fully transparent to the NetFlow Collector; or (2) the collector receives accurate information with respect to the location were the statistics were actually collected.

In the first case, the Data Export module groups the flows according to the NERs through which they could pass, and exports each group with the source address set to the respective NER. To set this IP address correctly the Data Export module maintains a map between the flows in F^{d} and the NERs through which they pass. This FlowToNER map is computed by the Flow Discovery module as can be seen in line 7 of FIG. 5.

In the second case, the exported datagrams contain statistics of flows that were installed on the same router. The Data Export module sets the source address of the datagrams to the IP of the router where the respective flows were installed.

In this section the experimental evaluation of NFO is presented. The experiments focus on evaluating the effect of flow assignment strategies on NFO performance. Two flow assignment strategies are considered: the greedy flow balancing algorithm as described above (denoted as Balanced) and the baseline strategy where flow-discovery entries are installed on the NERs (denoted as Baseline). It is Noted that, in the Baseline strategy, when a flow-discovery entry can be mapped to multiple NERs It was randomly chosen one of the NERs on which to install the entry. This is done in order to allow fair comparison of the strategies with respect to the number of installed flow-discovery entries.

In order to factor out the effect of the Scheduler on the load created by monitoring, a baseline scheduler that sets the timeout of every installed active flow entry to 60 seconds was used. Flow-discovery entries never expire and the timeouts of flows installed by the controller in order to route traffic are kept at their default value.

The evaluation was performed with 11-routers' and 37-routers' tree topologies generated by Mininet. In order to show that NFO performs well also on more complex topologies the AS-1755 (EBONE, Amsterdam) and the AS-4755 (VSNL India) topologies were included. The former contains 15 routers and the latter 31 routers. In the simulations of the present invention, each one of the routers was connected to ten virtual machines. These ten virtual machines were assigned IP addresses within a unique /28 subnet.

Every simulation was executed for 300 seconds. The simulation execution was split into cycles of 1 to 10 seconds. In order to simulate communication between virtual machines, during each cycle every virtual machine continuously pinged ten random peers. In order to fairly compare between evaluation scenarios, the same random seed for choosing the set of ping destinations was used. Since the timeouts of flow-table entries are constant, the shorter the flows, the more load they create on the routers. When flows are short-leaved (e.g. cycle=1 sec) new flow entries are installed before the old ones expire.

The larger the flow-tables, the more entries they can accommodate before generating full flow-table errors. The experiments were carried out with flow-tables of 300 to 3000 entries. Although, there are products using larger tables, in the current experimental settings 3,000 entries are enough to handle all flows.

The NFO performance was evaluated with 1, 2, and 3 randomly selected NERs. Once NERs were chosen, the Flow Discovery module generated flow-discovery entries for the flows which were intended to pass through at least one NER. Flow discovery entries were assigned to routers and installed after the network was built and the virtual machines started pinging each other in order to let the controller learn the network.

During the experiment, the number of flow-table entries that were installed (denoted as total flow entries) were recorded including flow-discovery entries, active flow entries, and other entries installed by the controller. Intuitively, the network entries were not uniformly distributed across the network routers. Some routers were more heavily loaded than others due to their central position or traffic vagaries. The load on the routers can become even more dispersed if the monitoring load is not well- balanced.

Occasionally, flow-tables become overfull especially when they are small. To capture the impact of overfull flow tables the number of full flow-table errors were measured. In order to obtain deeper insights into network performance during monitoring, the number of packet-in messages were measured separately for monitoring and for routing purposes (denoted as routing packet-in messages and monitoring packet-in messages respectively). Routing packet-in messages also included packet-in messages sent for ARP and any other network health check.

Every installed flow-table entry, except the static flow-discovery entries, should eventually be removed. Routing flow-table entries installed by the controller are removed without generating the flow-removed messages. However, the active flow entries installed by NFO do generate these messages. The number of flow-removed messages were measured as a proxy to the amount of collected statistics.

Excess control messages also consume the controller resources as known in the art. In this experiment the memory usage of Floodlight controller was measured.

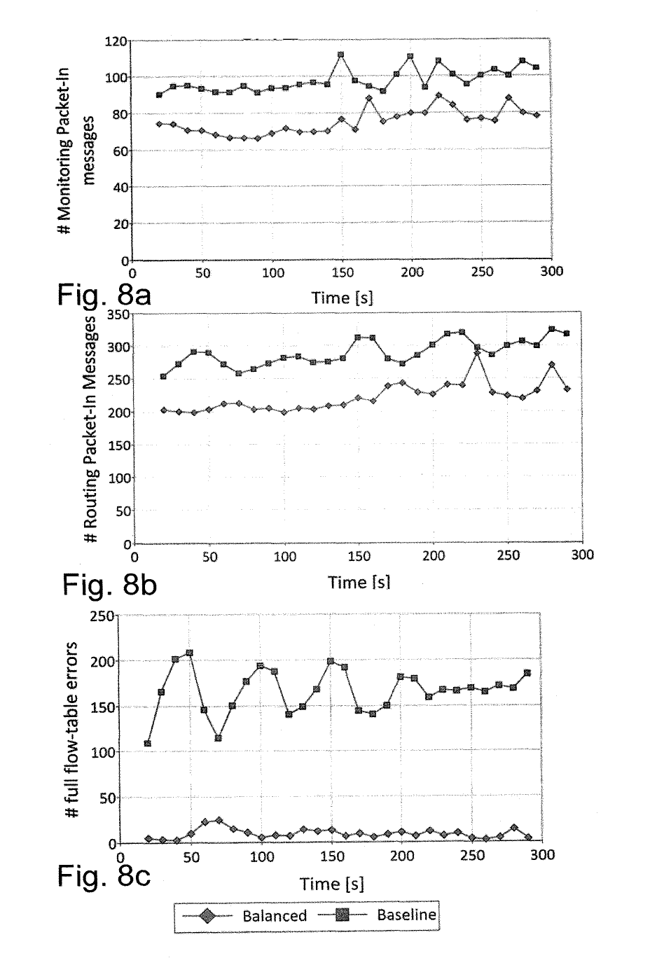

The NFO performance evaluation results are presented in FIGS. 8-15. The NFO performance were analyzed from different perspectives and compared two flow assignment strategies: Baseline and Balanced. A qualitative comparison of NFO to related works is presented in Section V.

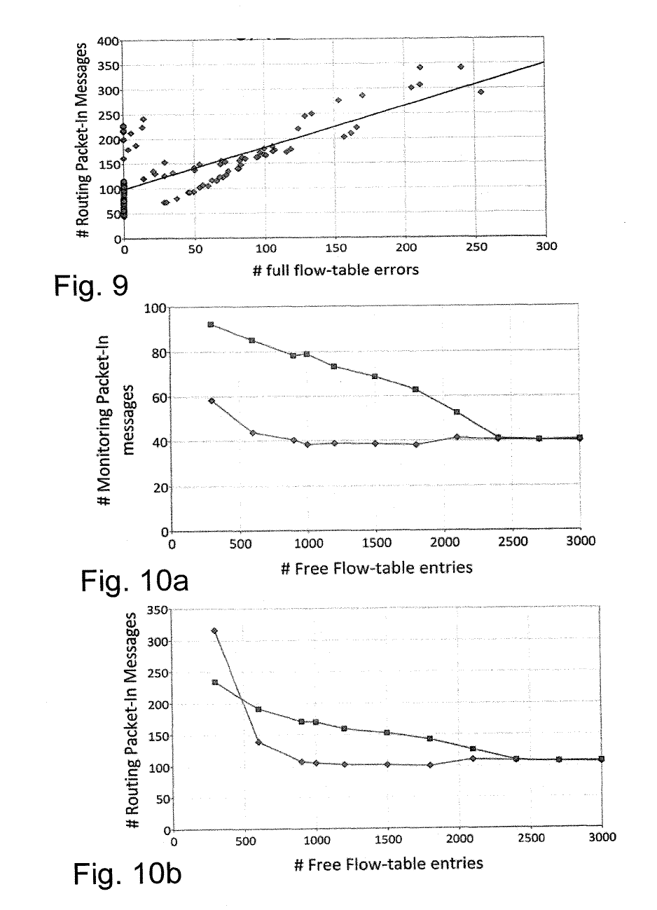

FIGS. 8a-8c show that balancing the monitoring load across routers using the greedy flow assignment algorithm greatly reduces the chance for full flow-table errors compared to using only the NERs for monitoring. Although this result is intuitive, it stands in contrast to the common practice of network monitoring where the fewest possible routers are selected to cover as many flows as possible.Full flow-tables also increase the number of control messages used for monitoring as well as for packet routing. Packet-in messages are used to notify the controller that a flow-table entry needs to be installed in order to handle this packet and all further packets from the same flow. However, if the flow-table entry is not installed, since the flow-table is full, further packets trigger additional packet-in messages consuming router-controller bandwidth, CPU, memory, etc. For example,it can be seen in FIG. 9 where the correlation between packet-in messages and full flow-table errors is apparent.

To better understand the relation between effective flow assignment and the effect of flow balancing on the network, in FIG. 14 the total number of packet-in messages were plotted as a function of the Gini coefficient. It can be seen that the more balanced the distribution of free flow-table entries is (smaller Gini coefficient) the less redundant packet-in messages are in the network.

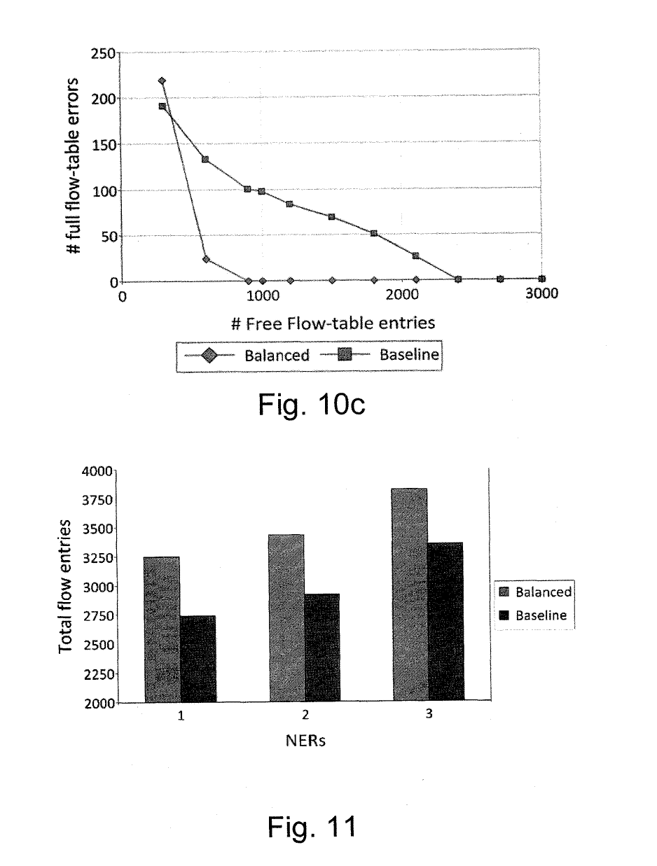

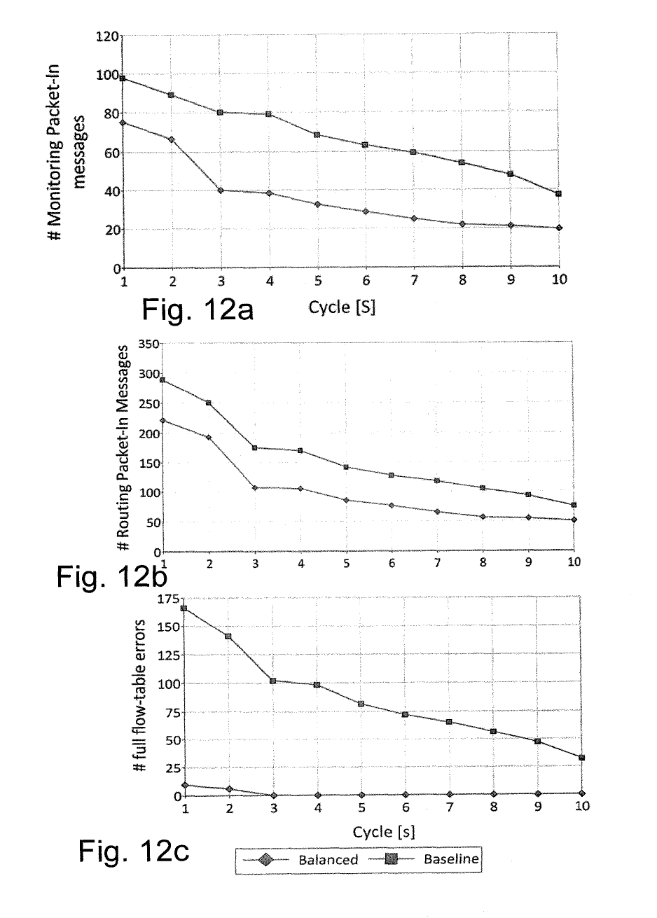

FIGS. 10a-10c and 12a-12c present the simulation results as the function of flow-table size and flow duration respectively. With a balanced distribution of flow records, it was possible to completely avoid errors (and excess control messages) with only 900 entries in the flow-tables of the routers in our experiment as shown in FIGS. 10a-10c. However, when the statistics are collected only from the NERs, these routers need at least 2,400 entries in their flow-tables. In addition to saving router resources, the proposed monitoring optimization saves controller resources as can be seen from the lower memory consumption of Floodlight in FIG. 14.

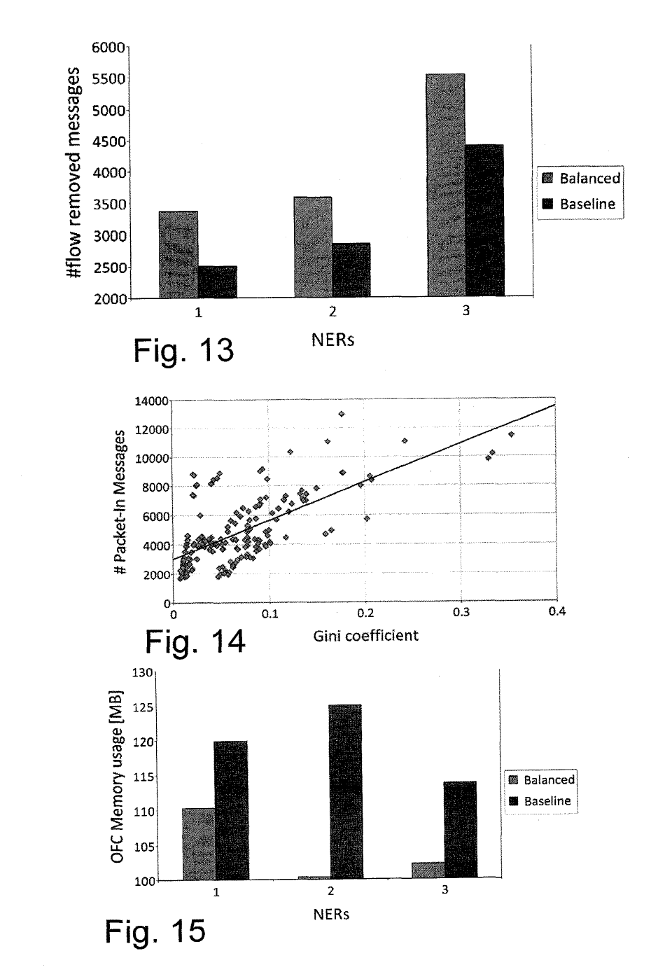

Furthermore, the greedy Flow Assignment algorithm of the present invention enables the installment of more flow-table entries for monitoring purposes as depicted in FIG. 11. Thus more flow statistics are collected (see FIG. 13) which increases monitoring accuracy along the IP space dimension.

1. A system for mediating between Software-Defined-Networking and common flow-based monitoring systems, said system comprises:
a. an SDN controller, operating in SDN technology;
b. NetFlow to OpenFlow module, for receiving flow statistics from said SDN controller, converting the flow statistics to datagram, and exporting the datagram by standard monitoring traffic protocols to a remote monitoring system; and
c. said remote monitoring system, for receiving the datagram from said NetFlow to OpenFlow module.

2. A system according to claim 1, wherein said SDN technology is implemented by OpenFlow protocol.

3. A system according to claim 1, wherein said remote monitoring system is a Network Intrusion Detection System (NIDS).

4. A system according to claim 1, wherein said NetFlow to OpenFlow module comprises the following modules:
a. a flow discovery module, for generating aggregated flow-discovery entries by selecting routes passing through selected routers, and determining source and target subnets at each endpoint;
b. a flow assignment module, for balancing monitoring load across network routers, by instructing said flows discovery module as to where each flow-discovery entry should be installed, based on the capacities and occupations of said routers flow-tables,
c. a scheduler module, for installing for each active flow a schedule of entries expirations, thereby to collect high granularity statistics; and
d. data export module, for listening to flow-removed messages from each of said active flows installed by said scheduler module, generating corresponding NetFlow datagrams, and sending said corresponding NetFlow datagrams to a remote NetFlow Collector.

5. A method for mediating between SDN networks and common flow-based Network based Intrusion Detection Systems, wherein a NetFlow to OpenFlow module receives flow statistics from said SDN controller, converts said flow statistics to datagram and exports said datagram by standard monitoring traffic protocols; and wherein said method comprising the steps of:
a. selecting routes passing through NetFlow Enable Routers;
b. generating aggregated flow discovery entries;
c. installing said aggregated flow discovery entries;
d. listening to packet-in messages;
e. setting the monitoring frequency of an active flow;
f. installing an exact match entry for said active flow on router R;
g. listening to flow remove messages;
h. extracting statistic of said flow from said flow;
i. exporting NetFlow datagram;
j. updating monitoring frequency of said active flow;
k. reinstalling said active flow on said same router.

6. A method according to claim 5, comprising the steps of:
a. generating aggregated flow-discovery entries by selecting routes passing through selected routers, and determining source and target address spaces at each endpoint;
b. balancing monitoring load across network routers, by instructing said flows discovery module as to where each flow-discovery entry should be installed, based on the capacities and occupation of said routers flow-tables;
c. installing for active flows and scheduling said entries expiration in order to collect high granularity statistics; and
d. listening to flow-removed messages from said active flows installed by said Scheduler module, generating corresponding NetFlow datagrams and sending said corresponding NetFlow datagrams to a remote NetFlow Collector.

7. A method according to claim 5, wherein balancing monitoring load across network routers comprises the steps of:
a. receiving as an input a set of flow-discovery entries, and routes of respective flows;
b. balancing a monitoring load relying on a number of free flow-table entries in each candidate router;
c. iterating over all flow-discovery entries in the order of non-increasing load;
d. assigning each entry to a router along said router path that has a maximal number of free flow-table entries; and
e. updating a number of free flow-table entries, based on an expected load on said router.

8. A method for discovering new active flows, which pass in a network and collecting statistic about said active flows; said method comprises the steps of:
a. initializing a set of flow-discovery entries and a map of flows to selected routers through which said flows pass;
b. iterating over all subnets connected to all source and destination routers;
c. generating for each pair of subnets a flow-discovery entry;
d. saving for future use only if at least one of said selected routers is along its route;
e. saving the selected routers where each flow could have been monitored, for later use;
f. invoking Flows Assignment module to determine a location of each flow discovery entry;
g. installing on the assigned router each of said generated flow-discovery entries; and
h. transferring to Data Export module two maps, which: (a) define for each flow on which selected router each of said flows could have been collected; and (b) where each of said flows is collected in the OpenFlow network.
